(19) United States
(12) Patent Application Publication
(10) Pub. No.: US 2016/0343124 A1
(43) Pub. Date: Nov. 24, 2016

(54) METHOD AND SYSTEM FOR DETERMINING A STATUS OF ONE OR MORE TANKS IN A PARTICULAR LOCATION

(71) Applicant: Genscape Intangible Holding, Inc., Louisville, KY (US)

(72) Inventors: Brent James Sundheimer, Louisville, KY (US); Paul Heiniger, Louisville, KY (US); Deirdre Alphenaar, Prospect, KY (US)

(21) Appl. No.: 15/158,302

(22) Filed: May 18, 2016

Related U.S. Application Data
(60) Provisional application No. 62/163,789, filed on May 19, 2015.

(51) Int. Cl. G06T 7/00; H04N 5/33; G06Q 30/02; G01F 23/292; G06Q 40/04; H04W 4/02

(52) U.S. Cl. CPC G06T 7/0004; G06Q 40/04; H04W 4/02; G06Q 30/0201; G01F 23/292; H04N 5/33; G06T 7/0051

(57) ABSTRACT

A method for determining a status of one or more tanks in a particular location or an amount of a commodity stored in a particular location comprises the steps of: storing information associated with each of the one or more tanks in a database; periodically conducting an inspection of each of the one or more tanks, including using a sensor to acquire a three-dimensional data set; analyzing the three-dimensional data set to determine a status of each of the one or more tanks and/or to calculate an amount of the commodity that is stored in one or more tanks; and communicating information about the status of each of the one or more tanks and/or the amount of the commodity that is stored in one or more tanks at the particular location to a market participant.

### CROSS-REFERENCE TO RELATED APPLICATIONS

The present application claims priority to U.S. Patent Application Ser. No. 62/163,789 filed on May 19, 2015, which is incorporated herein by reference.

### BACKGROUND OF THE INVENTION

The present invention relates to determining a status of one or more tanks in a particular location and/or an amount of crude oil or other commodity that is stored in one or more tanks in a particular location, such as a tank farm or storage hub.

Liquid energy commodities, such as crude oil, comprise a multi-billion dollar economic market. These commodities are bought and sold by many parties, and as with any traded market, information about the traded commodities is very valuable to market participants. Specifically, the operations of the various components and facilities of the production, transportation, storage, and distribution systems for each of these commodities can have significant impacts on the price and availability of these commodities, making information about said operations valuable. Furthermore, such information generally is not disclosed publicly by the various component and facility owners or operators, and access to said information is therefore limited.

For example, crude oil is typically stored in large, above-ground tanks. A collection of such above-ground tanks at a particular location is often referred to as a “tank farm.” To the extent that a collection of such above-ground tanks is located near the intersection of many outgoing and/or incoming pipelines or transportation (tanker ship, truck, rail, etc.) receipt and delivery points (or nodes), it may also be referred to as a “storage hub.” Similarly, other liquid energy commodities of interest, including natural gas liquid derivatives (or condensates) and refined petroleum products (such as diesel, gasoline, fuels oils, and biofuels), may also be stored in such above-ground tanks on a tank farm or at a storage hub.

In any event, whether crude oil, other liquid energy commodity, or other commodity activity at tank farms or storage hubs is of interest to market participants, along with regulatory agencies and owner-operators.

U.S. Pat. No. 8,842,874, which is incorporated herein by reference, describes certain methods and systems for determining an amount of crude oil or similar liquid energy commodity that is stored in a particular location, such as a tank farm or storage hub.

As described in U.S. Pat. No. 8,842,874, each tank in a particular location is researched using available resources or visual inspection, and all relevant information about each tank, including volume capacity information, tank type (i.e., floating roof or fixed roof), roof type, physical dimensions, emissions data and/or any other information contained in tank construction permits, safety permits, and/or other accessible sources, is stored in a database at a central processing facility.

On a predetermined schedule or in substantially real-time, an inspection of each tank at the particular location is conducted. Such an inspection includes the collection of one or more photographic images (i.e., visible spectrum) or video of each tank, the collection of infrared images or video of each tank, and/or the collection of other types of images of each tank. The collected images of each tank are then transmitted to a central processing facility and stored in a database.

At the central processing facility, an analysis of the collected images is conducted, which allows for a calculation of the amount of crude oil in each tank.

With respect to the analysis of a tank with an external floating roof (EFR), one preferred form of analysis is to determine the height of the roof relative to the top of the selected tank using standard image pixel number determination techniques. Based on the determined height of the roof (which is indicative of the liquid level) and the volume capacity information and/or the physical dimensions of the selected tank stored in the database at the central processing facility, the amount of crude oil in the tank can be calculated.

With respect to the analysis of a tank with an external floating roof (EFR), another preferred form of analysis is an image processing analysis to model the top, roof, and base of a tank as parallel elliptical planes and to determine the roof height by calculating the separation distance between these elliptical planes. Based on the determined height of the roof relative to the base and/or the top of the tank (which again is indicative of the liquid level) and the volume capacity information and/or the physical dimensions of the selected tank stored in the database at the central processing facility, the amount of crude oil in the tank again can be calculated.

Various other methods or techniques can also be employed to complement or provide additional measurements for determining the height of the tank roof.

For example, the roof of an EFR tank is supported from the center of the roof by an extended arm that is generally connected to a ladder, which, in turn, is supported on the outside of the tank wall. The ladder allows access to the roof of the tank for inspection and maintenance purposes. To determine or confirm the height of the tank roof, the angle of inclination of the arm can be measured relative to a defined reference on the tank.

For another example, in determining the height of the roof of an EFR tank, shadows of a tank can be analyzed. Specifically, under certain natural sunlit conditions, shadows from the tank walls may be visible on the tank roof and on the ground. The area or other measure of the size of the crescent-shaped shadows which are cast from the tank wall onto the tank roof and/or the ground vary with the roof height. For tanks of equal size and illumination angle with respect to the sun's position, the area of the crescent-shaped shadow is smaller in the tank with the higher liquid level and larger in the tank with the lower liquid level. The ratio of the areas of the internally cast crescent-shaped shadow to the externally cast crescent-shaped shadow can be used to determine relative roof height of the two tanks

With respect to tanks with fixed roofs (IFR), the liquid level within a selected tank can be ascertained from collected infrared images, as the temperature of the stored oil is different than that of the air above it in the tank. One preferred form of analysis to determine the height of the liquid level in the tank is to measure the pixel distance from the liquid-gas boundary to the base of the tank. Based on the ascertained liquid level within the tank and the volume capacity information and/or the physical dimensions of the selected tank stored in the database at the central processing facility, the amount of crude oil in the tank can again be calculated.

As described in U.S. Pat. No. 8,842,874, once the analysis of each tank in a particular location is completed, the calculated amounts can then be communicated to market participants and other interested parties, e.g., third parties who would not ordinarily have ready access to such information about the amount of crude oil in storage at a given time. By summing the volumes in all of the tanks or in a grouping of selected tanks, information about the total amount of crude oil at the particular location or in the grouping of selected tanks (for example, tanks owned by a particular company or the amounts of crude oil of a certain type) can also be calculated and communicated to market participants and other interested parties. It is contemplated and preferred that such communication to third-party market participants could be achieved through electronic mail delivery and/or through export of the data to an access-controlled Internet web site, which market participants can access through a common Internet browser program.

As described in U.S. Pat. No. 8,842,874, a system for determining an amount of a liquid energy commodity stored in a tank in accordance with the present invention includes: (a) a tank information receiving module for receiving and processing tank information, including volume capacity information, storing such information in a database; (b) an image receiving module for receiving and processing images of one or more tanks, storing such images in a database; (c) an analysis module for querying the databases and analyzing the images of each tank to determine a liquid level for each tank; (d) a calculation module for calculating the amount of the liquid energy commodity in each tank based on the determined liquid level and the volume capacity information from the database; and (e) a communications module for communicating information about the liquid energy commodity to a third-party market participant.

With respect to the acquisition and collection of images and/or other data about each tank, imaging and sensing technology is now available that will generate a point cloud of three-dimensional coordinates (i.e., a 3D point cloud) from acquired imagery, where each data point is registered to a geospatial coordinate system, so that its location in space is also known and stored. For example, WaldoAir Corp. of Franklin, Tenn. manufactures and distributes its XCAM-B camera, which can be used to collect data and generate such a 3D point cloud. It should be noted that data which includes two dimensions plus height, often referred to as 2.5D, is included in the term “3D point cloud” as that term is used in the present application, as three dimensions are at least partially represented. Furthermore, as the term is used in the present application, a “3D point cloud” also includes a point cloud with more than three dimensions, with, for example, the addition of a time dimension.

The raw image data from the XCAM-B camera or another sensor is processed using certain software to generate the 3D point cloud; for example, one such commercially available software product is licensed by Pix4D SA of Lausanne, Switzerland. Regardless of which camera or sensor or processing software is used, the resultant data is three-dimensional, where each data coordinate in the three-dimensional data set (or 3D point cloud) represents geospatial and/or other information pertaining to a point in three-dimensional space. Depending on the data acquisition technology deployed, each data coordinate in the three-dimensional data set (or 3D point cloud) may represent a geospatial location in addition to some physical parameter, which may include, but is not limited to, a color intensity, a thermal emissivity value, a relative reflectivity value, etc. The three-dimensional data set (or 3D point cloud) can represent the data as collected in raw form by the imaging or sensing system or a data set where some standard pixel interpolations, value averaging, or other default system noise reduction processing have been applied to the data.

Thus, it would be desirable to acquire a three-dimensional data set (or 3D point cloud) to represent storage tanks with external floating roofs (EFR) or fixed roof tanks (IFR), and then use that three-dimensional data set to determine a status of one or more tanks in a particular location and/or an amount of crude oil or similar commodity that is stored in one or more tanks in a particular location.

### SUMMARY OF THE INVENTION

The present invention is a method and system for determining a status of one or more tanks in a particular location and/or an amount of crude oil or other commodity that is stored in one or more tanks in a particular location, such as a tank farm or storage hub, a method and system that makes use of a three-dimensional data set (or 3D point cloud) that is representative of storage tanks with external floating roofs (EFR) or fixed roof tanks (IFR).

In accordance with the method and system of the present invention, each tank in a particular location is researched using publicly available resources, regulatory resources, owner-operator resources, visual inspection, or otherwise, and all relevant information about each tank, including volume capacity information, tank type (i.e., floating roof or fixed roof), roof type, physical characteristics and dimensions, emissions data, and/or any other information contained in tank construction permits, safety permits, or other accessible sources, is stored in a database, which may be hosted at a central processing facility.

A single tank or cluster of tanks may also be associated with connected pipelines and/or other receipt and delivery points (or nodes) in a broader supply chain network, such as delivery berths at a port where the tank resides or a truck or rail line connected to a tank farm of interest. Information about interconnections between components may also be stored in the database.

At some point in time, an inspection of each tank at the particular location is conducted. For example, such an inspection may be an aerial inspection, in which helicopters, airplanes, unmanned aerial vehicles (UAV) or drones, or remote-controlled aircraft fly over the location. For another example, the inspection may be conducted by space-based satellites or drones during a pass-over of the location of interest. Irrespective of how the inspection is conducted, such an inspection includes the collection of data for each tank (or collection of tanks). Specifically, the sensor (or sensors), in combination with certain processing software, is used to acquire and generate a three-dimensional data set (i.e., a 3D point cloud), where each data point is representative of a point on a surface of interest and is (or can be) registered to a geospatial coordinate system.

The acquired three-dimensional data set (i.e., a 3D point cloud) is transmitted to a central processing facility and stored in a database. Alternatively, the acquired three-dimensional data set could be stored locally, for example, in a memory component associated with the sensor acquiring the three-dimensional data, for subsequent analysis.

An analysis of the three-dimensional data set is conducted, which allows for a calculation of the amount (or volume) of crude oil or other commodity in each tank and/or other determinations of status of each tank.

With respect to the “status” of each tank, this term can refer to, for example: operational status, such as full, empty, in maintenance, under construction, or under demolition. This term can also refer to economic status, such as: (i) speculative status, i.e., commodity is being stored to benefit from future higher prices; (ii) transactional status, i.e., the commodity stored serves a constant demand sink; or (iii) leased space status (i.e., the tank is being leased). This term can also refer to network status, such as: (i) buffer, i.e., the commodity stored is used as a buffer between two nodes in a network; (ii) valve, i.e., the stored commodity is present to manage pipeline pressures; or (iii) mixing/blending area, i.e., the presence of two commodity types (or one or more types of one commodity) reflects that the tank serves as a mixing/blending area.

After the analysis of the three-dimensional data set is completed, it is then possible to calculate liquid content (inventory level) and/or other volumes associated with the three-dimensional tank structure.

In addition to calculating liquid content, three-dimensional volumes for other tank components (roof, walls, wall rims, wall protrusions, roof armature, ladders, roof vents, roof protrusions, and so on) can be used to determine other physical states of a tank life cycle, including, but not limited to, construction, hydrotesting, maintenance, venting, deconstruction, non-operation, safety testing, content quality testing, and so on.

Once the analysis of each tank in a particular location is completed, the calculated amounts or other status can then be communicated to market participants and other interested parties, e.g., third parties who would not ordinarily have ready access to such information about the amount of crude oil or other commodity in storage or status of the tanks at a given time. By summing the volumes in all of the tanks or in a grouping of selected tanks, information about the total amount of crude oil or other commodity at the particular location or in the grouping of selected tanks (for example, tanks owned by a particular company or the amounts of crude oil of a certain type) can also be calculated and communicated to market participants and other interested parties. It is contemplated and preferred that such communication to market participants could be achieved through electronic mail delivery and/or through export of the data to an access-controlled Internet web site, which market participants can access through a common Internet browser program. Of course, communication of information and data to market participants may also be accomplished through a wide variety of other known communications means without departing from the spirit and scope of the present invention.

Furthermore, in addition to reporting the calculated amounts or other status of one or more tanks, other information can also be reported to market participants, including, for example, aggregated tank information, information about patterns of change, alerts on changes in operations of the tanks, alerts on correlated market conditions, and alerts on changes to associated infrastructure connected to a particular tank farm or storage hub.

The central processing facility hosts a digital computer program (i.e., computer-readable instructions executed by a processor of a computer) that includes appropriate modules for executing the requisite instructions (which are stored in a memory component) for performing the operational steps of the method described above. Alternatively, the digital computer program could be hosted locally in a memory component associated with the sensor acquiring the three-dimensional data. In either case, an exemplary system for determining an amount of a commodity stored in one or more tanks in accordance with the present invention includes: (a) a tank information receiving module for receiving and processing tank information, including volume capacity information, storing such information in a database; (b) a data receiving module for receiving three-dimensional data sets representative of the one or more tanks, storing such data sets in a database; (c) an analysis module for querying the databases and analyzing the three-dimensional data sets to determine a liquid level for each tank and/or status of each tank; (d) a calculation module for calculating the amount of the commodity in each tank based on the determined liquid level and the volume capacity information from the database and/or for making other determinations of status; and (e) a communications module for communicating information about the commodity to a market participant.

### DESCRIPTION OF THE DRAWINGS

FIG. 1 is a flow chart depicting the general functionality of an exemplary implementation of the method and system of the present invention;

FIG. 1A is a schematic representation of the core components in the exemplary implementation of FIG. 1;

FIG. 2 is a flow chart depicting the analysis of a storage tank with an external floating roof (EFR) in one exemplary implementation;

FIG. 3 is an exemplary two-dimensional (2D) image which is representative of a 3D point cloud for four storage tanks, where pixel intensity has been scaled according to height above mean sea level;

FIG. 4 is an exemplary two-dimensional representation (or image) of a 3D point cloud for a single tank, where the intensity level of each pixel is a measure of height above mean sea level (MSL) in meters;

FIG. 5 is an exemplary image which has been transformed using a radial log polar transform;

FIG. 6 is an exemplary histogram formed from certain pixels of FIG. 5 of the maximum intensity within a row of pixels;

FIG. 7 is an exemplary histogram of heights of the outer wall ring points based on FIG. 6;

FIG. 8 is an exemplary histogram illustrating the compilation of the points within a radial band which fall within a defined range of distances from the wall and calculating the median height; and

FIG. 9 is a tank capacity schematic.

### DETAILED DESCRIPTION OF THE INVENTION

The present invention is a method and system for determining a status of one or more tanks in a particular location and/or an amount of crude oil or other commodity that is stored in one or more tanks in a particular location, such as a tank farm or storage hub, a method and system that makes use of a three-dimensional data set (or 3D point cloud) that is representative of storage tanks with external floating roofs (EFR) or fixed roof tanks (IFR).

As discussed above, crude oil is typically stored in large, above-ground tanks. A tank has either: a floating roof, which is known as an external floating roof (EFR); or a fixed roof with a floating roof internal to the tank, which is known as an internal floating roof (IFR). For instance, in the United States, there is a large concentration of such crude oil tanks in tank farms located near Cushing, Okla., which makes this area a major trading hub for crude oil. The tank farms near Cushing, Okla. have a collective capacity in the range of 80 million barrels of crude oil. Similarly, other liquid energy commodities of interest, including natural gas liquids and refined petroleum products (such as diesel, gasoline, fuel oils, and biofuels) may also be stored in such above-ground tanks. In addition, tanks may be partially submerged underground, may be mounted in vertical or horizontal configurations above-ground (e.g., propane tanks), or the tanks may have spherical or other shapes depending on the commodity being stored (e.g., spherical butane tanks).

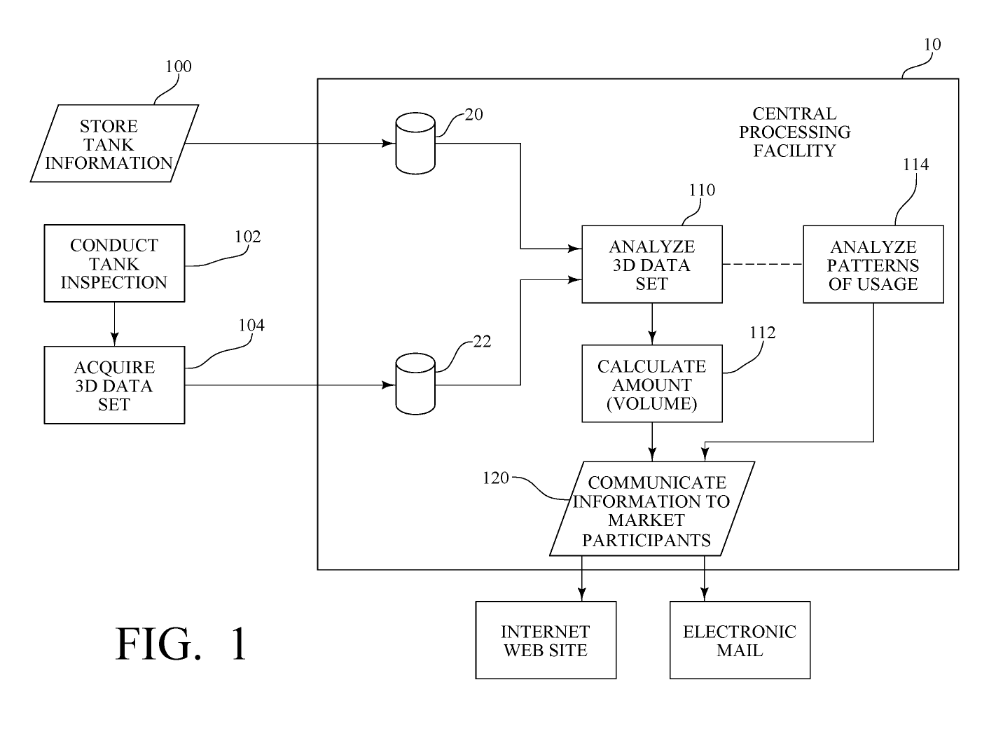

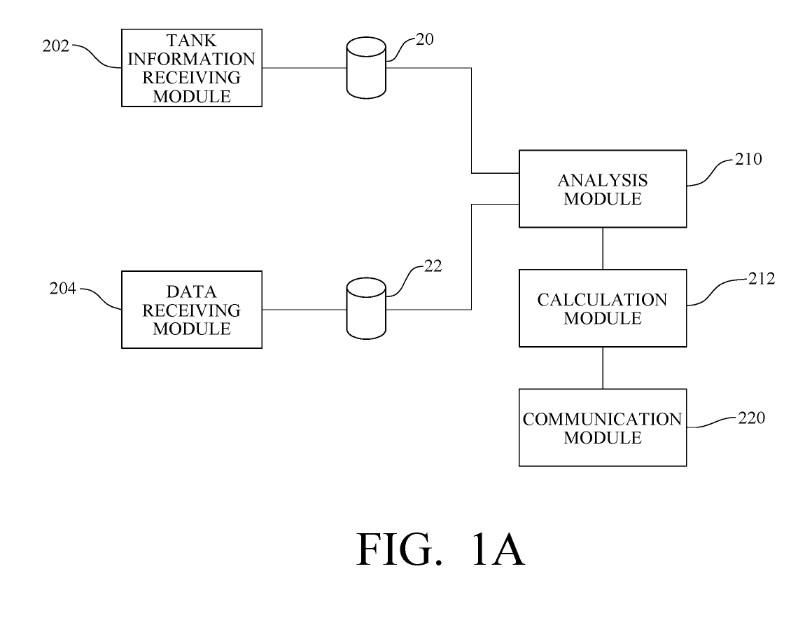

Referring now to FIG. 1, in accordance with the method and system of the present invention, each tank in a particular location is researched using publicly available resources, regulatory resources, owner-operator resources, visual inspection, or otherwise, and all relevant information about each tank, including volume capacity information, tank type (i.e., floating roof or fixed roof), roof type, physical characteristics and dimensions, emissions data, and/or any other information contained in tank construction permits, safety permits, or other accessible sources, is stored in a database 20, which may be hosted at a central processing facility 10, as indicated by block 100.

Furthermore, depending on the source and methods of their production, crude oils vary in chemical and physical properties and are typically classified by American Petroleum Institute gravity (or API number), which is a measure of how heavy or light a crude oil is relative to water. The API number or similar information about the type of crude oil stored in each tank may also be stored in the database 20.

A single tank or cluster of tanks may also be associated with connected pipelines and/or other receipt and delivery points (or nodes) in a broader supply chain network, such as delivery berths at a port where the tank resides or a truck or rail line connected to a tank farm of interest. Information about interconnections between components may also be stored in the database 20. For example, if a particular tank is connected to a gasoline receipt berth at a port, that particular tank may be classified as containing gasoline.

Lastly, if detailed information about particular tanks is unavailable, the method and system of the present invention may still be carried out, with all collected data stored and effectively time-stamped. Such collected data regarding tank observations can then be used as a reference set for future tank observations. The operations of a tank over time may then be matched to other reference tanks where detailed information is available. In this regard, characteristics including, but not limited to, tank material, color, condition, repair, physical modifications, and hazmat or other tank labels, can all be used to match a tank to other reference tanks. Similarly, data on general tank construction characteristics can also be stored in the database 20 to allow the automated matching of tanks to a reference database of tank types to indicate possible contents if this data is unavailable through other means.

At some point in time, an inspection of each tank at the particular location is conducted, as indicated by block 102 in the flow chart of FIG. 1. For example, such an inspection may be an aerial inspection, in which helicopters, airplanes, unmanned aerial vehicles (UAV) or drones, or remote-controlled aircraft fly over the location. For another example, the inspection may be conducted by space-based satellites or drones during a pass-over of the location of interest. Irrespective of how the inspection is conducted, such an inspection includes the collection of data for each tank (or collection of tanks). Specifically, the sensor (or sensors), in combination with certain processing software, is used to acquire and generate a three-dimensional data set (i.e., a 3D point cloud), where each data point is representative of a point on a surface of interest and is (or can be) registered to a geospatial coordinate system.

As described above, one possible sensor for use in the method and system of the present invention is the XCAM-B camera manufactured by WaldoAir Corp. of Franklin, Tenn. It should also be recognized that not only visual sensors (or cameras) may be used in the method and system of the present invention, but also many other sensors may be used to acquire a 3D point cloud for a tank or tank farm, including, but not limited to, infrared sensors, Light Detection and Ranging (LIDAR), Synthetic Aperture Radar (SAR), aerial sonar, airborne or remote Radio Detection and Ranging (RADAR), altimetry, and so on. Furthermore, multiple sensors may be used in combination, acquiring multiple images that are then used to generate a 3D point cloud, or a single sensor may acquire multiple images from various angles or perspectives to generate a 3D point cloud.

In most cases, such an inspection will be conducted on a predetermined schedule, but, in some other cases, the inspection can be triggered by an external event, such as, for example, a collection of signals from tanker ships inbound into a port tank farm area. In this regard, signals from an external system, such as a ship tracking system, may be used to identify that a particular tanker ship containing crude oil is headed to port, and an inspection can be automatically initiated and/or scheduled based on that information. In addition, a location may be inspected following a market event, such as an associated refinery shutdown, or as requested by a market participant.

The acquired three-dimensional data set (i.e., a 3D point cloud) is transmitted to a central processing facility 10 and stored in a database 22, as indicated by block 104 in the flow chart of FIG. 1. This database 22 may be separate from the database 20 described above, or the two databases 20, 22 may be integrated with one another. With respect to the transmission of the collected data, such transmission may be achieved through an Internet connection or any other data transmission technique, including, but not limited to, wireless communications, satellite communications, microwave communications, and/or a fiber optic link or similar landline transmission.

Alternatively, although not shown in FIG. 1, rather than transmitting the acquired three-dimensional data set to a central processing facility, the acquired three-dimensional data could be stored locally, for example, in a memory component associated with the sensor acquiring the three-dimensional data, for subsequent analysis.

At the central processing facility (or, alternatively, in a processor associated with the sensor acquiring the three-dimensional data), an analysis of the three-dimensional data set (i.e., a 3D point cloud) is conducted, as indicated by block 110 in the flow chart of FIG. 1, which allows for a calculation of the amount (or volume) of crude oil or other commodity in each tank and/or other determinations of status of each tank, as indicated by block 112 in the flow chart of FIG. 1.

With respect to the “status” of each tank, this term can refer to, for example: operational status, such as full, empty, in maintenance, under construction, or under demolition. This term can also refer to economic status, such as: (i) speculative status, i.e., commodity is being stored to benefit from future higher prices; (ii) transactional status, i.e., the commodity stored serves as a constant demand sink; or (iii) leased space status (i.e., the tank is being leased). This term can also refer to network status, such as: (i) buffer, i.e., the commodity is used as a buffer between two nodes in a network; (ii) valve, i.e., the stored commodity is present to manage pipeline pressures; or (iii) mixing/blending area, i.e., the presence of two commodity types (or varying quality of one commodity) reflects that the tank serves as a mixing/blending area.

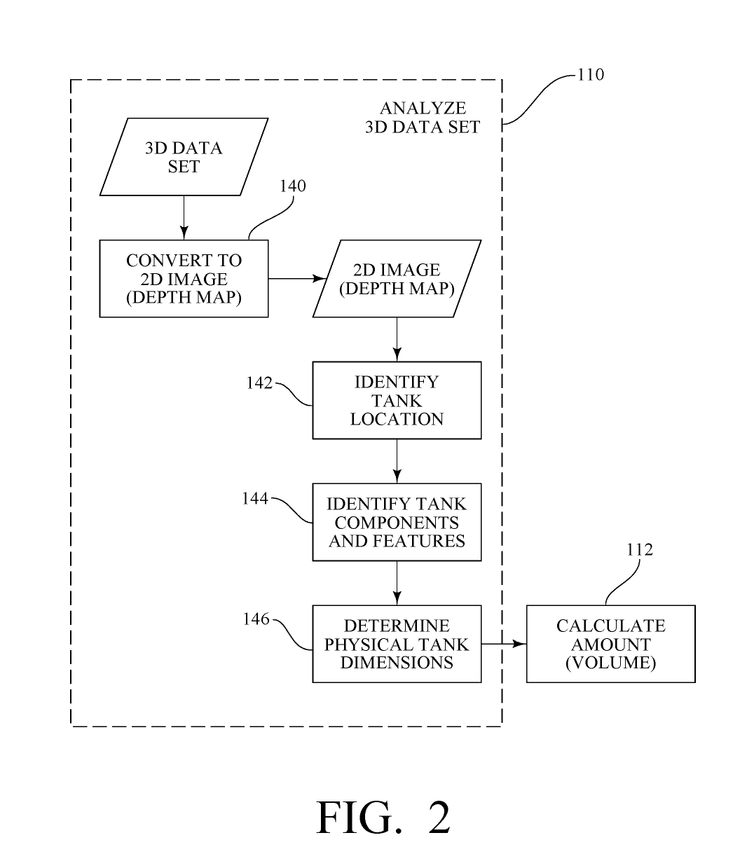

For example, with respect to an analysis of storage tanks with an external floating roof (EFR), and referring now to FIG. 2, the following steps are performed in one exemplary implementation.

1. Pre-Processing of the Three-Dimensional Data Set.

One preferred initial pre-processing step is to convert the three-dimensional data set (i.e., a 3D point cloud) into a two-dimensional (2D) depth map, as indicated by block 140 in FIG. 2. In this regard, it is advantageous to work with such a depth map, as this will speed subsequent processing significantly, as well as put the data into a more visually intuitive space. One way to achieve such conversion of the 3D point cloud is to create a two-dimensional image where the x-y coordinates of the 3D point cloud (which are indicative of the locations of the tanks) are translated so they have an x-y position in the 2D image. The dimensions for the two-dimensional image are chosen so that the resultant image maintains a pixel resolution that is sufficient relative to the initial spatial resolution of the original 3D point cloud to allow for the calculations which follow. For instance, one method of achieving the spatial transformation is to assign two-dimensional coordinates relative to a single reference point, for example, a corner or edge in the 3D point cloud. In this way, each point can be mapped into the two-dimensional image using its relative position to this defined reference point in the 3D point cloud. Further processing of the two-dimensional image to achieve a certain pixel resolution or aspect ratio or other visualization requirement can be achieved by using nearest-neighbor pixel interpolation or other interpolation techniques, which would be well understood by a person of ordinary skill in the art.

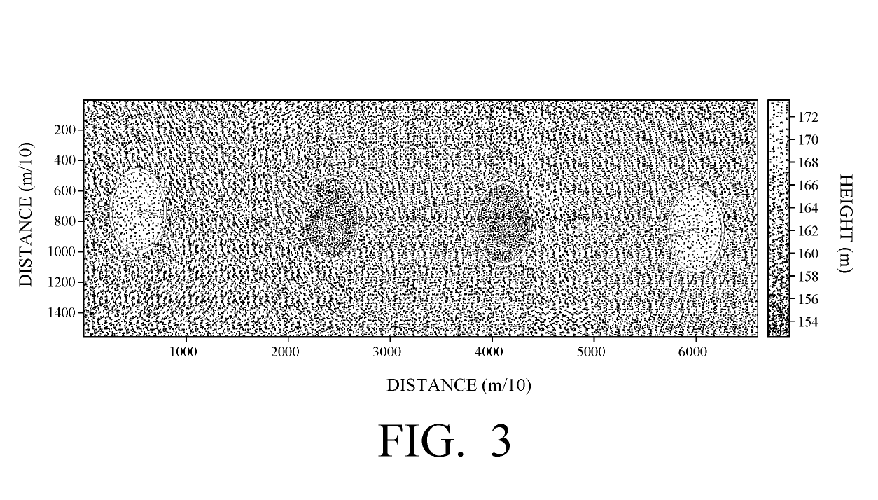

FIG. 3 is an exemplary two-dimensional (2D) image which is representative of the 3D point cloud for four storage tanks, where pixel intensity has been scaled according to height above mean sea level (MSL) in meters. Specifically, each pixel value in the 2D image is computed by averaging the z-coordinates (height) of the closest points in the point cloud. The 2D image shown thus represents the entire 3D point cloud. Of course, the 2D image can also represent any desired cross-sectional plane in the 3D point cloud where there is corresponding data acquired by the camera or other sensor. The color scaling of the 2D image can represent a height value or could also represent any other physical parameter or combination of parameters measured in the original 3D point cloud, depending on the camera or sensor used to acquire the data. This may include, but is not limited to, a color intensity, a thermal emissivity value, a relative surface reflectivity value, and so on.

Additionally, the 3D point cloud can be processed by directly segmenting the three-dimensional data into 3D regions of interest by converting the points in each segmented region into a mesh structure of interconnected points, or using other three-dimensional data handling techniques. This method is of specific importance in tank analysis, where subsets of the data can be tied to physical entities involved in subsequent computations, such as components and/or features of the tank (e.g., roof, wall, wall rims, roof armature, roof vents, and so on).

If the data in the 3D point cloud is geotagged, no further calibration is needed to convert the data to true distances, thus eliminating the need to reference the data set to a defined reference point as described above. Automatic processing of the 3D point cloud can therefore be performed to extract measurements of interest, such as roof height, tank diameter, tank height, and so on. An individual tank can be automatically assigned an absolute geospatial coordinate in terms of a latitude and longitude or a relative location coordinate relative to a local geospatial frame of reference, such as a tank farm. A relative location reference could be, for example, a location of a tank relative to a defined center point of the tank farm or a location of a tank within a defined sub-area of the tank farm owned by a particular owner/operator.

In the absence of a geotagged 3D point cloud or a partially geotagged data set, an external geospatial reference set can be used, and the data can be scaled manually or auto-registered with the external reference point such that it aligns with the true geolocation of the three-dimensional structure. Numerous three-dimensional computer vision alignment algorithms known to a person of ordinary skill in the art could also be used to align or co-register any two three-dimensional structures, and a geospatial alignment can thus be obtained.

2. Identify Tank Location.

For each tank image set acquired, there is an identification of the location of each tank or location relative to neighboring tanks or a tank farm area, as indicated by block 142 in FIG. 2. For a geotagged 3D point cloud, a tank center or other geo-reference point or reference area can be referenced from a priori reference data set containing information on tank location and other physical and operational data such as, but not limited to, tank type, size, owner, contents, inventory levels, status of operation, pipeline or other receipt or delivery point connectivity, and so on, where data is derived from available resources. In the absence of a geo-located reference for each tank image, the location of any individual tank can also be found automatically using a computer vision-based automatic recognition algorithm, such as a normalized cross correlation with a previous image of the tank. Specifically, the position of an individual tank can be referenced relative to a group of tanks in a defined tank farm or tank farm area. The position of the tank can also be referenced relative to other equipment, such as pipelines, refineries, etc., that have a fixed and known location.

In identifying the location of each tank, a recognition algorithm may use any defining characteristics of the tank as a recognizable object, such as, but not limited to, tank wall boundaries, position of roof armature, roof vents, tank image color or contrast, tank shape, tank pipeline connections, objects/shapes in the surrounding area, or tank location relative to a defined reference point in the tank farm. Furthermore, in the new tank builds, there may be a dynamic tracking and identification of new tank construction or deconstruction in an area of interest.

In addition, the recognition algorithm could be used to track and identify all tanks within a defined region where no previous information has been stored for each individual tank or tank farm area by referencing archived imagery within that defined region. Once a tank location is identified, the tank can be referenced to a pre-existing naming, numbering, or other identifiers stored in a database.

3. Identify and Segment Certain Tank Components and/or Features.

Referring again to FIG. 2, once an approximate location of a tank is found, there is an identification of certain tank components and/or features, as indicated by block 144 in FIG. 2. Specifically, a more precise boundary for each of the components and/or features of the tank required in subsequent analysis can be automatically detected. For instance, a floating roof of the identified tank can be found by a region segmentation algorithm based on a roof reference point, a radial search for the rim of the tank defined by local peaks at angles radiating out from the approximate center, or other technique known to a person of ordinary skill in the art.

For example, in one preferred implementation, a radial polar or radial log polar transform can be applied to locating the roof, wall of a tank, and surrounding ground to determine the relative heights of these components. A polar transform of an image is a mathematical operation which changes the coordinate system of the image such that each new point in the image is a representation of the distance from the center of the image and angle from the center of the image. A well-known formula for this transform is:

T=\sqrt{x²+y²}

φ=a tan 2(y,x) (1)

where x and y are the Cartesian coordinates, r is the distance from the center point, and is the angle from the center point of the image.

A log polar transform of an image is similar, but defined as a mathematical operation which changes the coordinate system of the image such that each new point in the image is a representation of the logarithm of the distance from the center and angle from the center of the image.

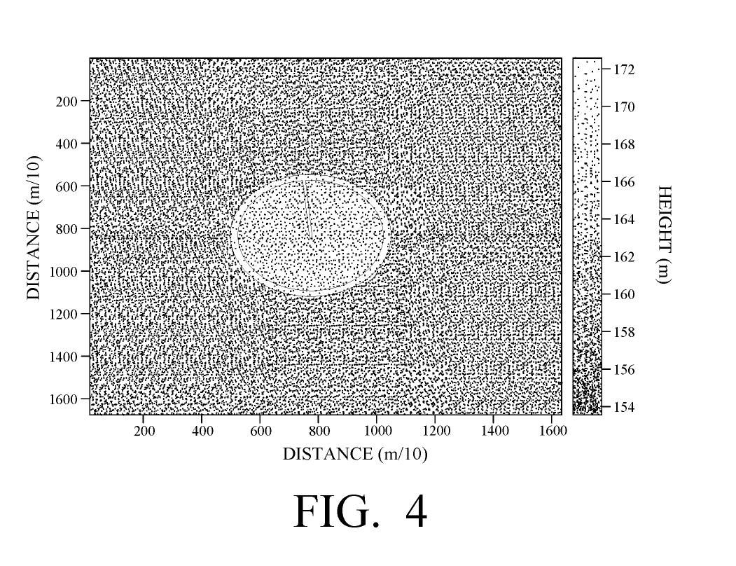

FIG. 4 is an exemplary two-dimensional representation (or image) of a 3D point cloud for a single tank, where the intensity level of each pixel is a measure of height above mean sea level (MSL) in meters.

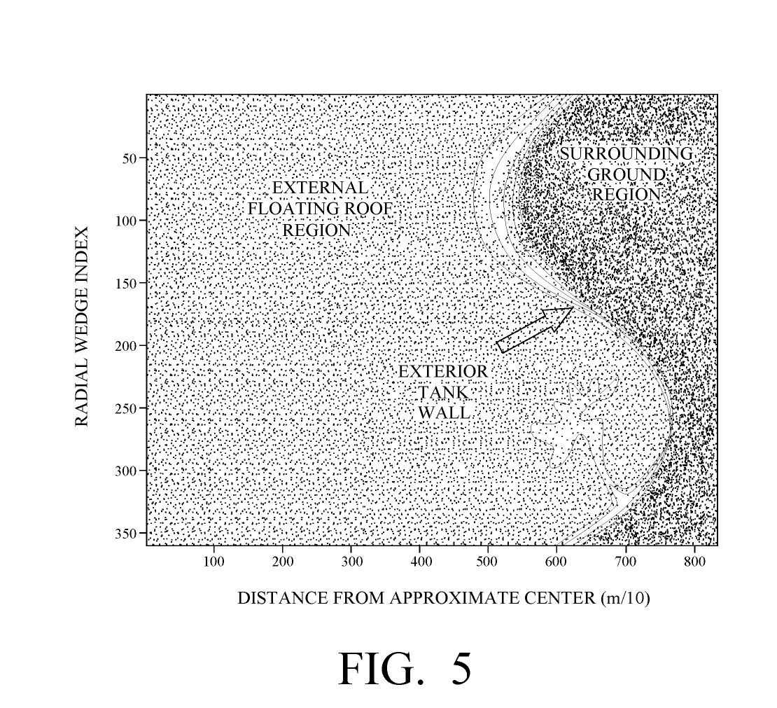

FIG. 5 is an exemplary image which has been transformed using a radial log polar transform, with (i) the x-axis representing the distance from the approximate center of the tank, (ii) the y-axis representing the angle from the center point of the image, and (iii) the intensity representing the height. The highest intensity pixels represents the wall and wall-associated components in the tank image.

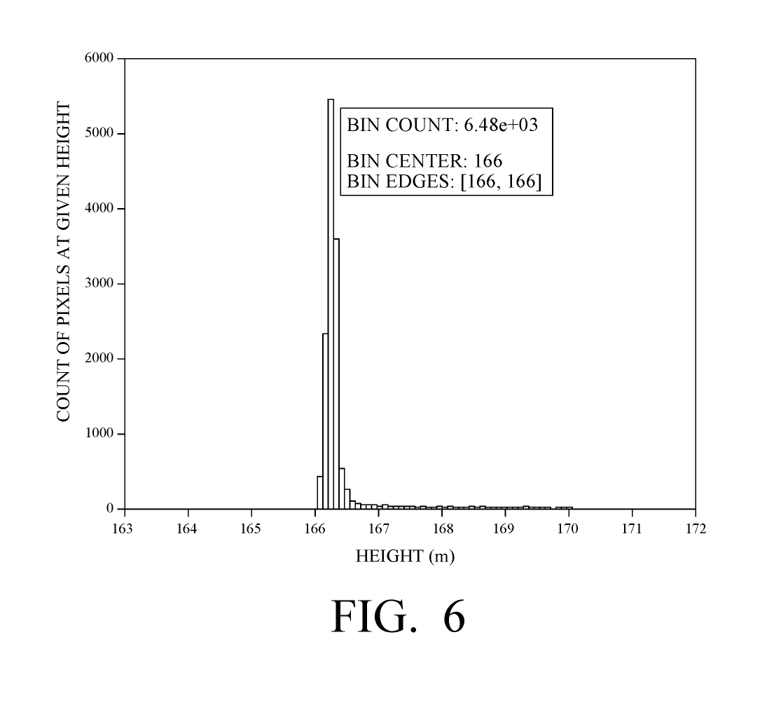

FIG. 6 is an exemplary histogram formed from the pixels of FIG. 5 where the x-axis represents the height above MSL (m), and the y-axis represents a count of pixels in each pixel intensity bin. FIG. 6 is generated by taking all pixels which lie to the left of the highest intensity pixels (wall region) in FIG. 5. The x-axis position of the peak of this histogram is the used to estimate the height of the EFR tank wall.

In a similar way to the automated detection of the tank wall, other tank components and features within the tank 3D point cloud could also be defined, extracted, and measured using similar automated analysis. Such components and/or features include, but are not limited to, roof, walls, wall rims, wall protrusions, roof armature, ladders, roof vents, roof protrusions, connected piping, and ground surrounding the exterior of the tank. Once automatically segmented as distinct tank components, these components can be defined as sub-regions for automated segmentation. Once segmented, the dimensions associated with each feature can be automatically computed. For easy visualization, segmented components can be assigned different colors in 2D images.

In an alternative visualization, colors can be assigned to 2D images based on changes to these components in time. In addition, a historical time series of 2D images can be used to represent and visualize components which are static with time (e.g., tank walls and tank structures) and those that are dynamic in time (e.g., roof level, roof armature, and roof vents).

4. Determine Physical Tank Dimensions (Including Roof Height).

Once a tank area in the 3D point cloud is defined and segmented into different tank components and/or features, such as roof, walls, wall rims, wall protrusions, roof armature, ladders, roof vents, roof protrusions, connected piping, and ground surrounding the exterior of the tank, and so on, using methods such as those described above, certain physical tank dimensions are determined, as indicated by block 146 in FIG. 2. Specifically, various automated analysis can be defined to calculate the difference in height between the derived roof area or a point on the roof and the defined wall or wall rim features as required. The height of the floating roof can also be calculated as the distance from the ground, distance from the bottom of the tank, or any combination of those measurements as well and/or a volume can be calculated based on a three-dimensional model. The following are sample methods to calculate heights and relative distances with respect to an identified tank.

a. The floating roof region may be defined as the region in the 3D point cloud which is bounded by a circumference of a higher region, referred to as the wall region. The ground region is the region which falls beyond the sloping region bounding the wall region. These regions can be calculated using multiple methods, and the methods presented below are non-exhaustive and are only meant for explanation of the method and system of the present invention.

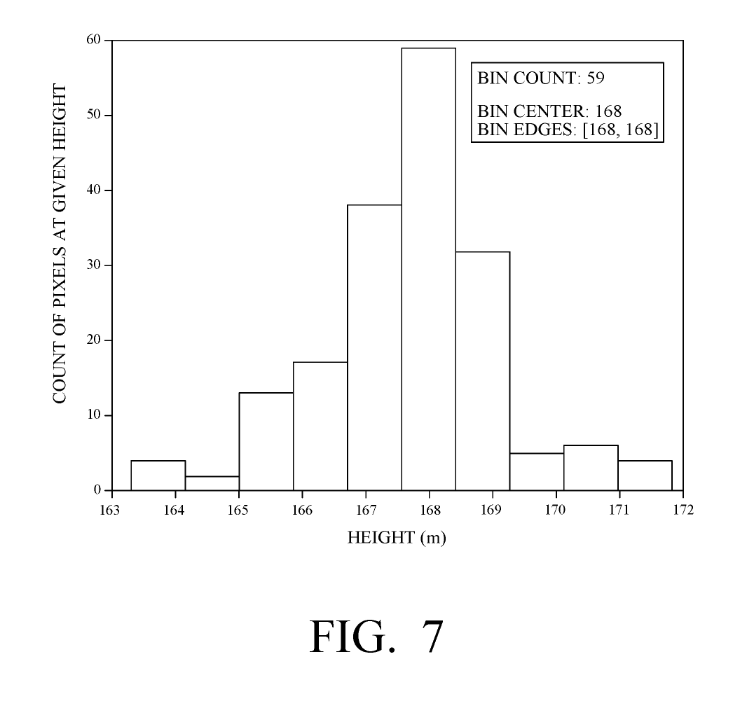

b. On the upper tank wall, there are commonly regular protrusions which extend above the wall. In order to eliminate these protrusions, a histogram of the heights of the outer wall ring points in the 3D point cloud is calculated. FIG. 7 is such an exemplary histogram of heights. The histogram is formed by taking each pixel in the image and assigning it to a bin based on its intensity or in this case, its height (as shown in FIG. 6). To assign a value to a bin in this case means to increment the value of the bin by one. The bins are chosen to be values between the minimum and maximum intensity values of the image region. Additionally, the number of bins should be carefully chosen to match the data samples collected across the wall region, so that the number of bins results in a histogram distribution whose bin width is optimally matched to the wall thickness. There should be several peaks in this histogram, and the lowest peak of a significant height will represent the mean measured position of the upper tank wall, which will disregard the protrusions and reduce noise in the model.

c. As with the upper tank wall, there are typically protrusions on the floating roof of the storage tank. In order to find an accurate position of the floating roof, a similar method is used. All points within the upper wall rim region are put into a histogram as above and the lowest peak of a significant height is taken to be the mean height of the roof.

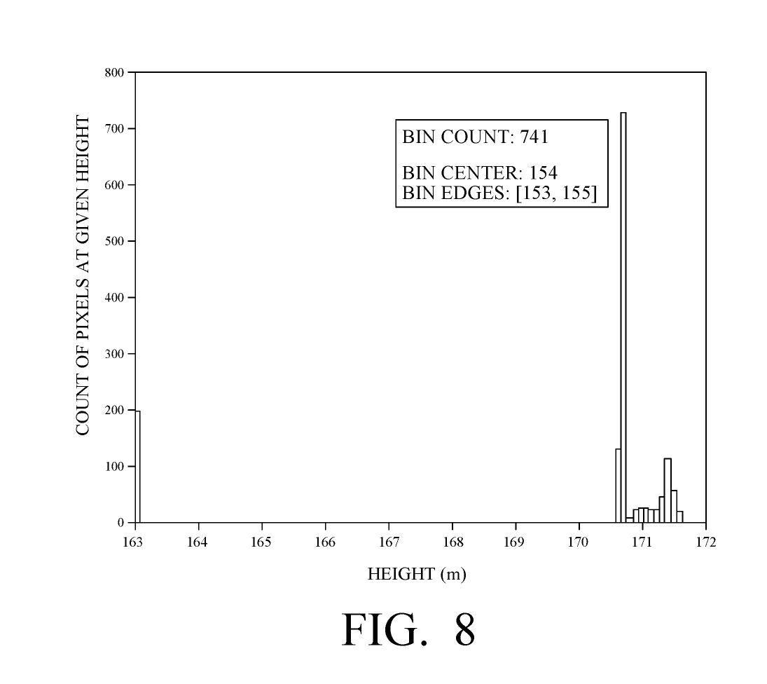

d. The ground level surrounding the tank wall can be calculated by compiling the points within a radial band which fall within a defined range of distances from the wall and calculating the median height. FIG. 8 is an exemplary histogram illustrating this calculation. This should account for any spurious returns as well as slight slopes and noise in the measurements in the ground level. Additionally, if the ground slopes on the exterior of the tank wall, the intersection of the ground and tank can be found by a line fit for both the slope of the ground and the tank side.

After the analysis of the three-dimensional data set (i.e., a 3D point cloud), as indicated by block 110 in FIGS. 1 and 2, is completed, it is then possible to calculate liquid content (inventory level) and/or other volumes associated with the three-dimensional tank structure, as indicated by block 112 in FIGS. 1 and 2.

For example, using the 2D segmentation methods described above, the points associated with various tank components can be identified and segmented in the 3D point cloud. Volumes can then be determined for each of the components (roof, walls, wall rims, wall protrusions, roof armature, ladders, roof vents, roof protrusions, connected piping, and ground surrounding the exterior of the tank, and so on). Additionally, the volume of the liquid in the tank can be approximated through finding the ground level as above and using the ground level and wall rim extent to approximate a three-dimensional model of the tank obtained through the remote measurements and calculating the volume included in the three-dimensional model of the tank. If the ground level is not calculated, a change in the amount of liquid can still be calculated by measuring the change in the height of the floating roof—either absolute height or distance from the calculated height of the wall rim.

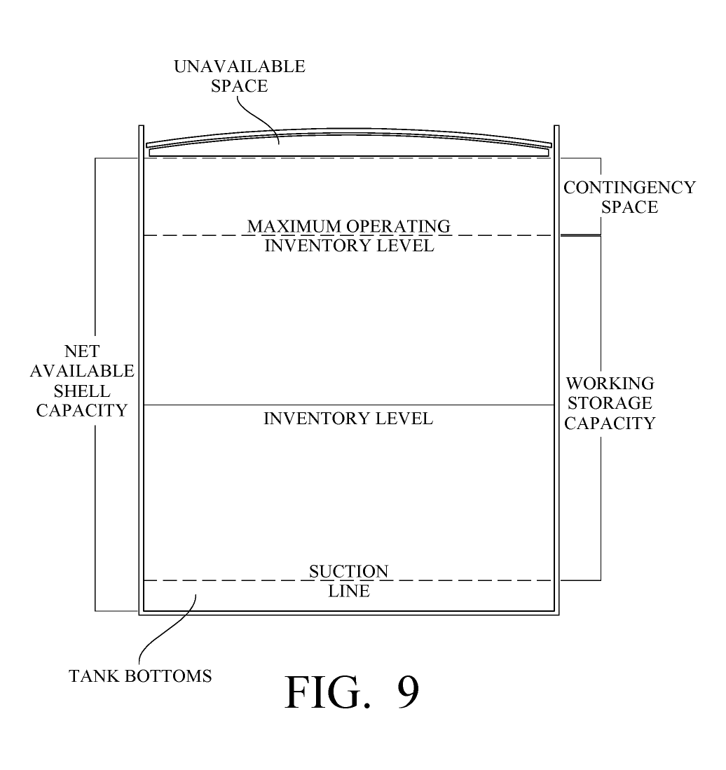

Once these metrics are calculated, the total amount (or volume) of liquid in the tank can be calculated through computation of the volume of the space. This calculation can be calibrated to correspond more accurate to true levels of liquid in the tank through other measurement methods, including correlation to publically available data, manual physical inspection of the unit, using publically available data to adjust the calculations based on tank physical architecture, or based on other remote measurement methodologies. In particular, volumes of interest associated with the commodity in storage in the tank include, but are not limited to, tank capacity, net available shell capacity, shell capacity, working storage capacity, tank inventory level, tank suction line, tank contingency space, tank unavailable space, and so on. In this regard, FIG. 9 is a tank capacity schematic, similar to that published by the U.S. Energy Information Administration.

As a further refinement, a tank and roof can be identified by their shape and can be identified by computer vision algorithms, thus allowing for more accurate volume calculations. Specifically, there are a variety of external floating roof types, and each one will have a different thickness which can affect the volume calculations. These types of roofs can be detected by various well-known computer vision algorithms, such as template matching. Also, there tend to be standard sizes and types of tanks which hold large amounts of liquid so by getting a rough size, a more accurate tank size can be approximated by comparing the dimensions to a known set of stored standard tank sizes and specifications which have been gathered a priori.

Another way to calculate the volume of liquid in the tank is by using the angle of objects connected to both the wall rim and the floating roof. On top of the floating roof is a ladder and/or armature which connects the wall rim to the tank roof. By knowing the length of the ladder and/or armature and observing the angle with the three-dimensional data, the relative position of the lid can be found, and the amount of liquid can be estimated.

For a particular data acquisition, as described above, the location of an individual tank is identified within a tank farm using a defined reference for the tank's geospatial location. Thus, for example, the log polar technique can be applied to find an approximate tank roof center. Using this reference point, various tank components can be auto-detected and segmented. Some number of these components are static physical entities, which do not vary in time, such as a tank wall or the surrounding ground exterior to a tank. Other components, such as the roof level, roof armature (angle), roof vents, and so on, vary over time. Once a roof level is measured for an individual tank, using tank location information, the relative roof level measured at other points in time can be accessed and compared to current roof level information. In this way, changes to tank roof level or other tank-associated volumetrics can be automatically determined for a tank.

In addition to using tank volumetrics to determine changes in tank content volume, three-dimensional volumes for other tank components (roof, walls, wall rims, wall protrusions, roof armature, ladders, roof vents, roof protrusions, and so on) can be used to determine other physical states of a tank life cycle, including, but not limited to, construction, hydrotesting, maintenance, venting, deconstruction, non-operation, safety testing, content quality testing, and so on. For example, a volume assessment can be made of the roof vents of an IFR tank to determine whether the roof vents are in the open or closed position. If the assessment concludes that the roof vents are in an open position, the tank may be in maintenance mode. A subsequent assessment that the roof vents have been closed may then, for example, trigger an alert that tank maintenance has ended.

Furthermore, although the above discussion focused on external floating roofs (EFR) and a 3D point cloud collected using photographic (visible spectrum) methods, a similar method can be employed for both EFR and internal floating roof (IFR) tanks using an infrared (thermal) or similar sensor. Since the liquid in a tank changes temperature at a slower rate than the air above it, as the day heats and cools, there is a temperature shift which is visible in the infrared spectrum of light. This temperature shift is evident by a shift in contrast at a constant horizontal level. In this case, each point in the acquired 3D point cloud is representative of a relative or absolute thermal emissivity associated with the various components of the tank, such as tank wall, tank roof, and tank liquid level, along with other tank-associated components, including, but not limited to, roof, walls, wall rims, wall protrusions, roof armature, ladders, roof vents, roof protrusions, connected piping, and ground surrounding the exterior of the tank, and so on. Specifically, by using certain techniques, such as the wall rim detection technique described above, the edge of the tank roof, along with the top and bottom of the tank wall, can be identified. From there, a radial band of intensity shift can be calculated by certain techniques, such as taking the mean intensity level at various heights and searching for an intensity shift which occurs across the circumference of the tank.

Also, for EFR tanks, there is normally a radial band visible above the normal liquid level around the inside of the tank, near the top of the wall rim. This radial band is an indicator of roof thickness, and detection of such a band can aid in making the volume calculations more accurate. The three-dimensional data can be used in the same manner as the above technique for IFR tanks, i.e., once a wall region is detected, by finding an intensity shift which is relatively uniform around the circumference of the inner wall region. The data can then be used to create more accurate volume calculations.

Furthermore, co-registration or precise overlay of a 3D thermal image with a 3D visual image will allow better liquid content differentiation, as compared to using visual or infrared (thermal) imagery alone. Specifically, thermal data associated with the finite physical thickness of the tank roof, along with thermal data associated with the bottom portion of the tank, which has essentially non-recoverable liquid volume (so called tank bottoms), can be precisely aligned in 3D space to determine a more accurate determination of the actual working volume of liquid in a tank. A relative inter-tank comparison of thermal signatures for tanks measured under the same ambient conditions can be used to determine differences in tank contents via a differentiated emissivity and thermal signatures. For example, tanks containing hotter liquids can indicate that the tanks are being heated (as in the case of gasoil in certain ambient temperatures), or that the liquid has recently been filled following a process where the liquid was heated and is therefore hotter than standing liquid in neighboring tanks. The accumulation of time-series data for a tank over a long period of time can be used to detect patterns which correlate with the observed signatures. In this way, two or more scenarios giving rise to the same thermal measurement (in this case a tank with an elevated temperature) can be differentiated. If the tank remains heated over long periods of time, then it likely contains heaters in the tank. On the other hand, if the heating is only seen for a fixed period following a tank fill, it is likely to indicate recently processed contents.

Once the analysis of each tank in a particular location is completed, the calculated amounts or other status can then be communicated to market participants and other interested parties, e.g., third parties who would not ordinarily have ready access to such information about the amount of crude oil or other commodity in storage or status of the tanks at a given time, as indicated by block 120 in the flow chart of FIG. 1. By summing the volumes in all of the tanks or in a grouping of selected tanks, information about the total amount of crude oil or other commodity at the particular location or in the grouping of selected tanks (for example, tanks owned by a particular company or the amounts of crude oil of a certain type) can also be calculated and communicated to market participants and other interested parties. It is contemplated and preferred that such communication to market participants could be achieved through electronic mail delivery and/or through export of the data to an access-controlled Internet web site, which market participants can access through a common Internet browser program. Of course, communication of information and data to market participants may also be accomplished through a wide variety of other known communications means without departing from the spirit and scope of the present invention.

Furthermore, in addition to reporting the calculated amounts or other status of one or more tanks, other information can also be reported to market participants, including, for example, aggregated tank information, information about patterns of change, alerts on changes in operations of the tanks, alerts on correlated market conditions, and alerts on changes to associated infrastructure connected to a particular tank farm or storage hub.

As a further refinement, and as also discussed in U.S. Pat. No. 8,842,874, an analysis can be conducted to determine the frequency at which the storage level in each tank varies over time in order to allow a grouping or classification of tanks by their pattern of usage, as indicated by block 114 in FIG. 1.

As a further refinement, and as also discussed in U.S. Pat. No. 8,842,874, directly-observed, third-party, or computed data, such as the coefficient of variance of the storage level data, can be displayed to provide a visualization of the activity of one or more tanks at a particular location (i.e., a tank farm or storage hub). Measuring the co-efficient of variance of tank volumes can profile the operational patterns of a particular location, such as a tank farm or a storage hub, as a whole. Changes in tank volumes generally correlate to local supply chain events. An example of this would be the rise in volumes following a delivery event (tanker ship, truck, rail, etc.) or a change in market price conditions, allowing more crude oil to flow into a region of tank storage. When crude oil is bought as a speculative trade, storage tends to increase until market prices rise, at which point it becomes economically advantageous to drain the crude oil from storage. When tracked to market origin, all such events constitute valuable information to market participants.

Furthermore, tracking tank dynamics over time can indicate when it is optimal to alert the market. For example, if a tank farm or a storage hub is seen to be filling from, holding, or releasing stored volumes into the transportation network (pipelines, tanker ships, trucks, rail, etc.), these activities accumulated over time can be matched to corresponding market events, such as price changes, demand disruption, speculative storage, and so on, for that tank farm or a storage hub and its market.

Referring now to the schematic representation of the core components in FIG. 1A, the central processing facility includes the above-described databases 20, 22. Furthermore, the central processing facility hosts a digital computer program (i.e., computer-readable instructions executed by a processor of a computer) that includes appropriate modules for executing the requisite instructions (which are stored in a memory component) for performing the operational steps of the method described above. Alternatively, the above-described databases 20, 22 could be stored locally, for example, in a memory component associated with the sensor acquiring the three-dimensional data, and the digital computer program could be similarly hosted locally in a memory component associated with the sensor acquiring the three-dimensional data. In either case, an exemplary system for determining an amount of a commodity stored in one or more tanks in accordance with the present invention includes: (a) a tank information receiving module 202 for receiving and processing tank information, including volume capacity information, storing such information in the database 20; (b) a data receiving module 204 for receiving three-dimensional data sets representative of the one or more tanks, storing such data sets in the database 22; (c) an analysis module 210 for querying the databases 20, 22 and analyzing the three-dimensional data sets to determine a liquid level for each tank and/or status of each tank; (d) a calculation module 212 for calculating the amount of the commodity in each tank based on the determined liquid level and the volume capacity information from the database 20 and/or for making other determinations of status; and (e) a communications module 220 for communicating information about the commodity to a market participant.

Finally, although the above description focused on liquid energy commodities, such as crude oil, other commodities, such as water, could be similarly monitored without departing from the spirit and scope of the present invention.

One of ordinary skill in the art will recognize that additional embodiments and implementations are also possible without departing from the teachings of the present invention. This detailed description, and particularly the specific details of the exemplary embodiments and implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for determining a status of one or more tanks in a particular location, comprising the steps of:
storing information associated with each of the one or more tanks at the particular location in a database;
periodically conducting an inspection of each of the one or more tanks at the particular location, including using a sensor to acquire a three-dimensional data set representative of the one or more tanks;
analyzing the three-dimensional data set, using a processor of a computer, to determine a status of each of the one or more tanks; and
communicating information about the status of each of the one or more tanks at the particular location to a market participant.

2. The method as recited in claim 1, and further comprising, prior to the step of analyzing the three-dimensional data set, the step of transmitting the three-dimensional data set to a central processing facility.

3. The method as recited in claim 1, wherein each data point in the three-dimensional data set is registered to a geospatial coordinate system.

4. The method as recited in claim 1, in which the sensor acquires the three-dimensional data set based on photographic imagery.

5. The method as recited in claim 1, in which the sensor acquires the three-dimensional data set based on infrared imagery.

6. The method as recited in claim 1, in which communicating the information about the status of each of the one or more tanks at the particular location includes exporting the information to an Internet web site accessible by the market participant.

7. A method for determining an amount of a commodity stored in one or more tanks in a particular location, comprising the steps of:
storing information associated with each of the one or more tanks at the particular location in a database, including volume capacity information;
periodically conducting an inspection of each of the one or more tanks at the particular location, including using a sensor acquiring a three-dimensional data set representative of the one or more tanks;
analyzing the three-dimensional data set, using a processor of a computer, to determine a liquid level for each of the one or more tanks;
calculating the amount of the commodity in each of the one or more tanks, using the processor of the computer, based on the determined liquid level and the volume capacity information retrieved from the database; and
communicating information about the amount of the commodity at the particular location to a market participant.

8. The method as recited in claim 7, and further comprising, prior to the step of analyzing the three-dimensional data set, the step of transmitting the three-dimensional data set to a central processing facility.

9. The method as recited in claim 7, wherein each data point in the three-dimensional data set is registered to a geospatial coordinate system.

10. The method as recited in claim 7, in which the sensor acquires the three-dimensional data set based on photographic imagery.

11. The method as recited in claim 7, in which the sensor acquires the three-dimensional data set based on infrared imagery.

12. The method as recited in claim 7, in which the commodity is crude oil.

13. The method as recited in claim 7, in which the commodity is selected from the group consisting of crude oil, natural gas liquid derivatives, and refined petroleum products.

14. The method as recited in claim 7, in which the commodity is water.

15. The method as recited in claim 7, in which communicating the information about the amount of the commodity at the particular location includes exporting the information to an Internet web site accessible by the market participant.

16. The method as recited in claim 7, wherein the step of analyzing the three-dimensional data set to determine the liquid level for each of the one or more tanks includes:
converting the three-dimensional data set into a two-dimensional depth map;
identifying a location of each of the one or more tanks in the two-dimensional depth map;
identifying and segmenting certain tank components and/or features in the two-dimensional depth map; and
determining physical tank dimensions and the liquid level for each of the one or more tanks.

17. A method for determining a status of one or more tanks in a particular location, comprising the steps of:
receiving information associated with each of the one or more tanks and storing the information in a database;
receiving a three-dimensional data set representative of the one or more tanks;
analyzing the three-dimensional data set, using a processor of a computer, to determine a status of each of the one or more tanks; and
communicating information about the status of each of the one or more tanks at the particular location to a market participant.

18. A method for determining an amount of a commodity stored in one or more tanks in a particular location, comprising the steps of:
receiving volume capacity information associated with each of the one or more tanks, and storing the volume capacity information in a database;
receiving a three-dimensional data set representative of the one or more tanks;
analyzing the three-dimensional data set, using a processor of a computer, to determine a liquid level for each of the one or more tanks;
calculating the amount of the commodity in each of the one or more tanks, using the processor of the computer, based on the determined liquid level and the volume capacity information retrieved from the database; and
communicating information about the amount of the commodity at the particular location to a market participant.

19. The method as recited in claim 13, in which the commodity is crude oil.

20. The method as recited in claim 18, in which the commodity is selected from the group consisting of crude oil, natural gas liquid derivatives, and refined petroleum products.

21. The method as recited in claim 18, in which the commodity is water.

22. The method as recited in claim 18, wherein the step of analyzing the three-dimensional data set to determine the liquid level for each of the one or more tanks includes:
converting the three-dimensional data set into a two-dimensional depth map;
identifying a location of each of the one or more tanks in the two-dimensional depth map;
identifying and segmenting certain tank components and/or features in the two-dimensional depth map; and
determining physical tank dimensions and the liquid level for each of the one or more tanks.

23. A system for determining an amount of a commodity stored in one or more tanks in a particular location, comprising:
a tank information receiving module for receiving and processing information about each of the one or more tanks in the particular location, including volume capacity information, and storing such information in a first database;
a data receiving module for receiving a three-dimensional data set representative of the one or more tanks and storing such data sets in a second database;
an analysis module for querying the first and second databases and analyzing the three-dimensional data set to determine a liquid level in each of the one or more tanks;
a calculation module for calculating the amount of the commodity in each of the one or more tanks based on the determined liquid level and the volume capacity information from the first database; and
a communications module for communicating information about the amount of the commodity in the one or more tanks in the particular location to a market participant.

24. The system as recited in claim 23, in which the first database and the second database are integrated into a single database.
